(19) United States
(12) Patent Application Publication
(10) Pub. No.: US 2004/0015392 A1
(43) Pub. Date: Jan. 22, 2004

(54) Shared freight rate system and invoicing method

(76) Inventors: Philip Hammel, Anderson, IN (US); David E. Wilson, South Fortville, IN (US)

Correspondence Address: DILWORTH PAXSON LLP, 3200 MELLON BANK CENTER, 1735 MARKET STREET, PHILADELPHIA, PA, 19103, US

(21) Appl. No.: 10/332,641

(22) PCT Filed: Jul. 9, 2001
(86) PCT No.: PCT/US01/41302

(51) Int. Cl. G06F 17/60

(52) U.S. Cl. 705/13; 705/417

(57) ABSTRACT

The present invention relates to a method and system for establishing freight rates or shipping charges associated with shipping goods in the trucking industry. More specifically, the present invention relates to a method for establishing the appropriate charge for shipping a partial load of goods when those goods are combined with other goods on the single truckload. The resulting system provides a shared cost/split invoicing system for combined less-then-truckload (LTL) shipments that: (i) is simple to implement, (ii) reduces the possibilities for human error, and (iii) fairly reflects each customer's fair and proportional cost to transport its goods from its selected point of origin to its selected destination. Also provided is the invoice resulting from the shared cost/split invoicing system which advantageously shows the customer both the charges for its portion of the combined load and how they were determined, while at the same time offering the customer a significant savings over prior art invoicing methods for shipping the same partial load.

### REFERENCE TO RELATED APPLICATIONS

This application claims priority to U.S. Provisional Application No. 60/217,197, filed Jul. 10, 2000.

### FIELD OF THE INVENTION

The present invention relates to a system and technique for establishing freight rates or shipping charges associated with shipping goods in the trucking industry, particularly partial loads.

### BACKGROUND OF THE INVENTION

The trucking industry accommodates the shipment of a variety of goods to a variety of locations. A single truckload shipment often comprises the goods of numerous customers. Therefore, it is necessary to establish an appropriate charge for each customer for a particular shipment.

The prior art for determining a less-than-truckload (LTL) shipping charge is a tariff-based system, based on the commodity classification and following a complex pattern. The tariff-based system requires referring to a significant number of individual schedule books, often by several different clerks simply to perform the steps needed to determine the shipping charge. In the tariff-based system, the shipping charge is decided by a series of basic determinations and calculations for a particular cargo.

First, the commodity is classified using the National Motor Freight Classification (NMFC) book. The NMFC groups commodities into 18 classes based on four composite transportation characteristics prescribed by the Interstate Commerce Commission (ICC) and the Department of Transportation's Surface Transportation Board. The four characteristics are 1) density; 2) stowability; 3) ease or difficulty in handling; and 4) liability. Thus, the NMFC classes are based mainly on the density and the description of the product. The entire rating system is then based on this classification.

Then, the origin basing point and the destination basing point of the shipment are identified to determine the overall shipment distance. The overall shipping distance is an additional factor used to generate the shipping rate for each shipment.

Next, the customer chooses a carrier. The carrier applies the tariff, or rate, based on the NMFC classification and the carrier's specific rating system. The ability of each carrier to develop their own rating system is another consideration for the customer when choosing a carrier.

Following this, a weight class is identified based on the commodity weight of the shipment. The weight class provides a span of weights that correspond to a specific rate or tariff. The carrier matches the identified weight class number and the NMFC classification number for the commodity to determine the class rate tariff. Then, the weight of the commodity is multiplied by the class rate tariff/100 to determine the base charge or non-deficit subtotal shipping charge for the goods.

In addition, the carrier typically applies an additional weight deficit charge for the amount the weight of the shipment is below a standard weight. The weight deficit charge is added to the base charge to obtain a gross shipping charge.

And, lastly, any discounts negotiated between the carrier and the customer are applied to determine the total shipping charge.

The convoluted nature of the prior art system resulted from the existence of various rate bureaus established by the Interstate Commerce Commission (ICC). With more than a dozen rate bureaus, each having its own shipping publications, and with certain bureaus dominating others, the complexity associated with a shipping rate charge determination is inevitable.

As can be appreciated, the prior art technique requires referring to a number of different data sources, generally found in a variety of different books, catalogs, and tables, along with tracking deficit weights and shipping discounts. The system is a cumbersome and inefficient method of establishing shipping charges.

Inherent in the existing methodology is the significant possibility of human error in making rate calculations. The multiplicity of tasks that must be performed and data sources that must be referenced combine to increase the likelihood of producing an incorrect shipping charge determination. Indeed, entire businesses have been formed for the sole purpose of reviewing shipping tariffs and recovering erroneous charges. Furthermore, the prior art technique for determining such charges is time-consuming, expensive, and difficult to learn.

Additionally, in the prior art LTL tariff-based system, the cost of transporting a partial load of freight is based only on that portion of the load, i.e., the cost is determined independently of any other freight carried in the same shipment. Thus, the amount the customer pays is predetermined regardless of how much other freight from other customers is carried on the shipment. As a result, in the prior art, the tariffs collected from a combination of customers may exceed that which is actually necessary to cover municipal, administration and other costs that the tariff was designed and intended to fund. Consequently, customers in many cases may be paying excessive or disproportionate tariffs that do not reflect otherwise economically justifiable shipping costs for certain combined load shipments.

Therefore, until the present invention, there was a need remained in the art, for a system of determining freight charges for combined LTL shipments that: (i) is simple to implement, (ii) reduces the possibilities for human error, and (iii) fairly reflects each customer's proportional cost to transport his/her goods from the point of origin to the point of destination.

### SUMMARY OF THE INVENTION

The present invention provides a greatly simplified method of establishing shipping charges for combined LTL shipments. The method of the present invention avoids the need to use tariffs and the National Motor Freight Classification (NMFC) cargo classifications, reducing the complexity of determining freight charges, and thereby reducing the margin for human error. The method of the present invention also reduces the cost to the customer as compared with the costs under the prior art tariff-based system.

The present invention establishes a fixed flat rate that is based on each customer's bill-of-lading weight as a portion of the total shipment weight. Under the system of the present invention, each paying customer bears a fair and proportionate shipping cost for the goods transported through a shared cost/split invoicing system.

The invention provides a method of establishing a shipping charge for combined less-then-truckload (LTL) shipments, based on a customer's freight weight portion of the total shipment freight weight, comprising: calculating the total shipping rate for the shipment based on total route mileage and flat shipping rate; calculating the hundred weight cost for the shipment based upon hundred weight of the shipment (total weight of the shipment in pounds, divided by 100); determining the hundred weight of the customer's goods on the shipment; and calculating the shipping cost to the customer. After the route is determined, the total mileage is calculated by summing together all of the mileage between each stop on the route utilizing zip codes of each location. The flat shipping rate for the shipment is determined by multiplying the total miles of the route by a customer-negotiated rate per mile. The total shipping rate for the shipment comprises the flat shipping rate for the shipment, plus any additional fees and charges. The hundred weight of the customer's goods is the weight, in pounds, of the customer's shipment divided by one hundred. The shipping cost to the customer is the customer's hundred weight multiplied by the hundred weight cost of the shipment. The shipping charge per customer is thus only that customer's LTL freight weight portion of the combined truckload shipment.

The invention further provides a method of invoicing a customer of an LTL shipment based on the customer's portion of the total shipment weight of the combined load, comprising: populating a database; entering data from each bill-of-lading into a computer system linked to the database; processing the data for a selected route; and creating an invoice for each customer portion of the combined load on the route. In accordance with the method, the populated database comprises shipping route and flat rate data. Processing of the data further comprises creating a total rate for the shipment, computing the customer's hundred weight and its cost.

The invention also provides the invoice produced in accordance with the present methods for a customer's shipping charge for the customer's less-then-truckload (LTL) freight weight portion of a combined truckload shipment. The resulting invoicing for each customer comprises the following data for each customer on a combined load: bill-of-lading, the weight of each bill-of-lading, and the sum of all bills-of lading for the combined load, wherein the invoice is apportioned by customer. Invoicing for each customer comprises charges and an amount due for each bill-of-lading, the hundred weight cost for the customer, and the total amount due for that customer's portion of the combined load. As a result, the invoice produced for each customer in accordance with the present methods, is specific to that customer's LTL freight weight portion of the combined truckload shipment.

These and other objects, features and advantages of the present invention will become more clear when the drawings, as well as the detailed description, are taken into consideration.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings, certain embodiment(s) which are presently preferred. It should be understood, however, that the invention is not limited to the precise arrangements shown.

FIGS. 1 and 2 are exemplary invoices which illustrate a shipping charge using the shared freight system according to the present invention for an 841 pound shipment of metal material from Lake Bluff, Ill. to Fayette, Ala.

FIG. 1 shows a sample invoice for the customer, Arvin Exhaust, for the first leg of the shipment.

FIG. 2 shows a sample invoice for the same customer, Arvin Exhaust, for the second leg of the shipment.

FIG. 3 shows an invoice for the same shipment as invoiced in FIG. 1, onto which an additional customer's goods have been added.

### DETAILED DESCRIPTION OF THE INVENTION

The invention provides a method for determining a shipping charge and a method for invoicing less-than-truckload (LTL) shipments based on the customer's portion of the total weight of the shipment. The shared freight system for establishing a shipping charge and invoicing each customer provides a rating system based on the freight weight of the customer's goods as a portion of the total freight weight of the shipment. An embodiment of the present invention is described by example, and compared and contrasted with the prior art tariff-based system, although the disclosure is not intended to limit the scope of the invention.

Thus, in order to illustrate the advantages of the shared freight system of the present invention, an example using the prior tariff-based system is first described. This is followed by an exemplified embodiment of the present invention showing the determination of a shipping charge using the shared cost i split invoicing system, which is in turn followed by a description of the split bill invoicing method associated therewith.

I. Determination of a Shipping Charge Using the Prior Art System

Tables 1 through 3 illustrate a shipping charge computation, for an actual shipment in February 1994, using the prior tariff-based system. The calculated shipping charge for a shipment of 841 pounds of metal material, in the form of automotive components, from Lake Bluff, Ill. to Fayette, Ala., is $109.28. The following describes the numerous steps to arrive at the shipping charge under the prior art tariff-based system.

First, in this actual LTL shipping scenario, a truck picked up the shipment from its local customer in Lake Bluff and delivered it to a “hub facility” in Chicago, Ill. A “hub facility” is a facility used to combine and distribute goods with common destinations. While at the Chicago hub facility, the goods were NMFC classified. The commodity was classified according to an appropriate commodity classification set forth in the NMFC book. NMFC classifications are based, on the weight, density, fragility of the commodity and whether or not it is a hazardous material. In this case, the commodity of metal material was classified as NMFC Class 70.

Following this, the origin and destination basing points, i.e., the zip codes for Lake Bluff, Ill. (60044) and Fayette, Ala. (35555) were identified (Table 1 and 3). Then, the carrier was chosen. The carrier chosen for this shipment was USF Holland. The carrier then applied a carrier developed tariff rate, in this case TNT 502. Once the carrier was chosen, a carrier-supplied database provided charts, as shown on Tables 1 through 3, used to generate the tariff.

Once classified, goods having common regional destinations were loaded onto a truck for transport to another hub facility. In the present example, the second hub was located in Nashville, Tenn., where the load is broken down for transport to lesser hub facilities. For goods destined for Fayette, Ala., the lesser hub facility would typically be Birmingham, Ala. At Birmingham, the load was broken down for delivery to the designated final destinations, e.g., Fayette, Ala.

As shown in Table 1, in this example, the commodity weight of 841 pounds lies between the weight class of M5C with a standard weight of 500 pounds, and M1M, with a standard weight of 1000 pounds. When a commodity weight falls between the weight classes, the rate used in the prior art is the smaller of either: the commodity weight multiplied by the higher rate, or the commodity weight multiplied by the lower rate plus the weight deficit multiplied by the lower rate. The chart shown in Table 1 has predetermined the weight break for this calculation, and shows the maximum commodity weight for each weight class rate. Thus, as shown on Table 1, the commodity weight of 841 pounds in accordance with prior art methods would use the rate of the M1M class with an additional weight deficit charge.

TABLE 1
Origin 60044
Destination 35555
Class 70

| | | Weight |
|---|---|---|
| Weight | Rate | Break |
| MC | 85.54 | 197 |
| L5C | 43.36 | 415 |
| M5G | 35.99 | 759 |
| M1M | 27.32 | 1618 |
| M2M | 22.11 | 3530 |
| M5M | 15.61 | 7770 |
| M10M | 12.13 | 13652 |
| M20M | 8.28 | 24057 |
| M30M | 6.64 | 34698 |
| M40M | 5.76 | |

TAB - Next Class
SHIFT + TAB − Previous Class
<- To Move Window ->
ESC - Quit

The weight deficit charge is based on the difference of the weight of the commodity from the standard weight of the weight class. Thus, a commodity weight of 841 has a weight deficit of 1000−841 or 159.

As shown on Table 1, the carrier's class rate tariff for the origin and destination of the present example, a NMFC classification of 70, and a weight class M1M was 27.23. (This class rate tariff is also depicted in the tables of NMFC Class versus weight classes shown in Table 4). The weight of the goods was then multiplied by the class rate tariff/100 to determine the non-deficit subtotal base shipping charge for the goods, i.e. 841 pounds×$27.32/100=$229.76.

Next, the weight deficit charge was calculated by multiplying the weight deficit, in pounds, by the class rate tariff. The weight deficit charge was calculated to be 159 pounds×$27.32/100=$43.44. The base shipping charge and weight deficit charge were summed to obtain a gross shipping charge, i.e., $229.76+$43.44=$273.20 (Table 2).

TABLE 2
TTN 502

| | |
|---|---|
| Origin Zip | 60044 IL |
| Destination Zip | 35555 AL |
| Rate Basis # | 00700B |

Finally, any discounts, agreed upon between the customer and the carrier, are applied to the gross shipping charge to obtain the total shipping charge. As shown on Table 2, in the present example showing prior art methods, a 60% discount, which amounted to $273.20×0.6=$163.92. Subtracting this discount from the gross shipping charge of $273.20, the total charge for shipping 841 pounds of NMFC Class 70 goods from Lake Bluff, Ill. to Fayette, Ala. was $109.28 (Table 3).

TABLE 3

| Class | Weight | Rate | Charge |
|---|---|---|---|
| 70 | 841 | 27.32 | 229.76 |
| Deficit | 159 | 27.32 | 43.44 |
| Gross | 1000 | | 273.20 |
| LTL Discount | | 60.00% | −163.92 |
| Net Charge | | | $ 109.28 |

| | |
|---|---|
| F5 - Options | F7 - Calculator |
| F6 - Class Notes <OFF> | ESC - QUIT |

II. Determination of a Shipping Charge Using the Present Shared Freight System

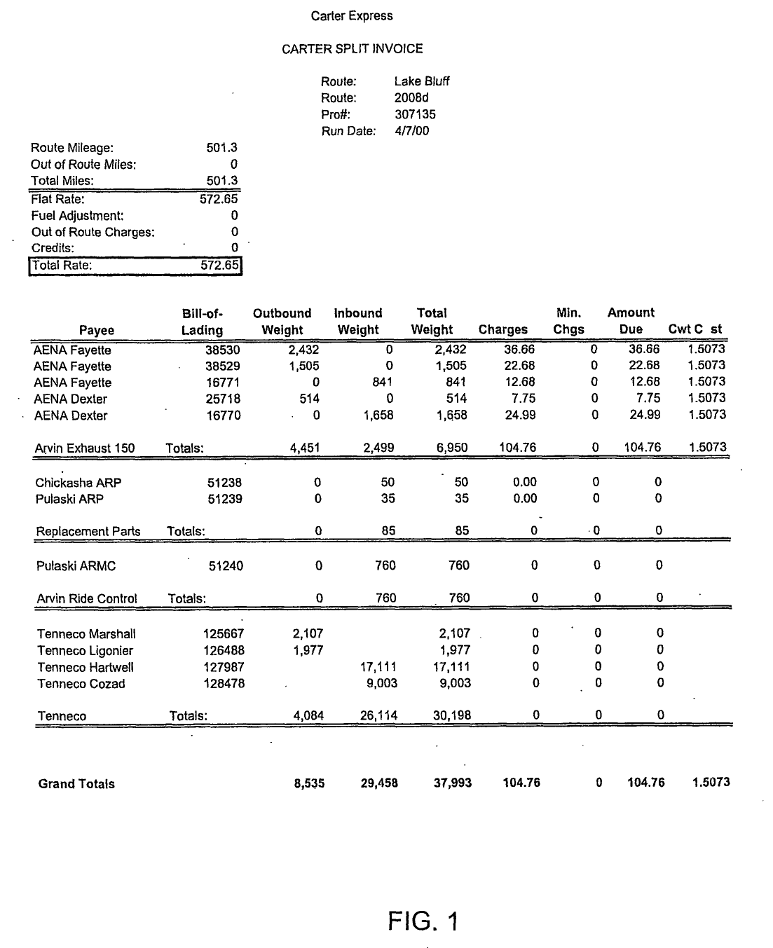

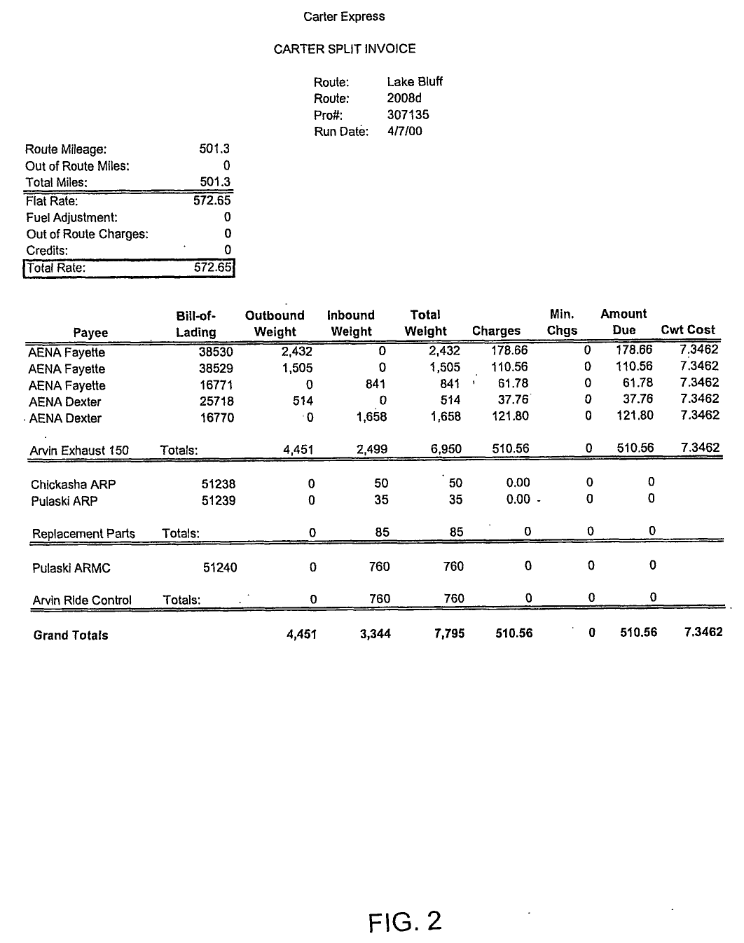

In contrast to prior art methods, FIGS. 1 and 2 and Table 4 reflect the simplified and less costly mechanics of shipping the same 841 pounds of metal material from Lake Bluff, Ill. to Fayette, Ala. using the shared freight invoicing system of the present invention. Unlike prior art shipping charge systems, the system of the present invention avoids all use of tariffs, and thus eliminates the inherent complexities and potential for human error that are associated with such tariffs. The present system charges a user in proportion to the weight contribution of his/her goods to the total weight of a shipment. Accordingly, shipping charges are fairly and logically distributed among the several paying customers that ship on a typical LTL shipment. As a result, in most cases the shipping charges paid to ship certain goods using the shared freight invoicing system of the present invention may be substantially less than those paid to ship the same weight of goods using a conventional tariff-based system.

As shown on FIGS. 1 and 2 and Table 4, the shipment of goods from Lake Bluff, Ill. to Fayette, Ala. involves a multiple leg journey. In the first leg, freight was shipped from Lake Bluff, Ill. to a hub facility in Alexandria, Ind. The total mileage, round trip, from Lake Bluff, Ill. to Alexandria, Ind., as shown on FIG. 1, for the shipment used in this example, conducted on Apr. 7, 2000, was 501.3 miles.

First, a “flat shipping rate” for the entire truck is determined based on the total mileage and not based on the commodities being shipped as in the tariff-based system. Specifically, the “flat shipping rate” equals the total mileage multiplied by a rate per mile negotiated with the customer. In the first leg of the present example, the customer-negotiated rate per mile for the customer, Arvin Exhaust, was $1.142323 per mile. Thus, the flat shipping rate in this example was 501.3 miles×$1.142323 per mile=$572.65 for the round trip. As shown, there were no additional charges or credits associated with this shipment. Hence, the total shipping rate for the round trip shipment was $572.65.

The trucking industry uses the “hundred weight” or “Cwt” for calculating shipping charges using the shipment weights. The “Cwt” is the total weight divided by 100. Thus, the “Cwt cost” is the cost of each 100 pounds of freight. The use of Cwt and the Cwt cost provides a means to understand ongoing costs irrespective of volume. Therefore, the total freight weight carried by the truck for the round trip is first divided by 100. In the present example, the total freight weight, 7,795 pounds, divided by 100 is 77.95 pounds. Then, to calculate the Cwt cost, the total shipping charge is divided by the total freight weight (Cwt). Thus, in the present example, the Cwt cost for the shipment is $572.65/77.95 pounds=$7.3462 per Cwt).

Accordingly, since 841 pounds (or 8.41 Cwt) of cargo is shipped at a Cwt cost of $7.3462, the shipping charge for shipping 841 pounds of goods from Lake Bluff, Ill. to the Alexandria, Ind. hub facility using the shared freight invoicing system of the present invention is $61.78 (8.41 Cwt×$7.3462 per Cwt) (Table 4).

Similarly, FIG. 2 shows the cost of the second leg of the journey from the Alexandria, Ind. hub facility to the Fayette, Ala. final designation. As seen in FIG. 2, the total mileage, round trip, from Alexandria, Ind. to Fayette, Ala. for the shipment used in this example, conducted on Apr. 10, 2000, was 1102.0 miles.

Again, the flat shipping rate for the entire truck is determined based on the total mileage and not the commodities being shipped. As stated above, the flat rate equals the total mileage multiplied by a customer negotiated rate per mile charge. In the second leg of the present example, the rate per mile charge for the customer, Arvin Exhaust, is $1.142323 per mile. Thus, the flat shipping rate is 1102.0 miles×$1.142323 per mile $1,258.84. As in the previous example, there were no additional charges or credits associated with this shipment. Hence, the total shipping rate for the round trip shipment was $1,258.84.

The hundred weight or “Cwt” cost for that shipment is then determined. The total freight weight carried by the truck for the second leg was 59,815 pounds, round trip. The total weight divided by 100 is 59,815/100=598.15 pounds. The total shipping rate is then divided by the total weight to get the Cwt cost. In the present example, the Cwt cost for the second leg is $1,258.84/598.15 pounds=$2.1046 per Cwt.

Thus, since 841 pounds (or 8.41 Cwt) of cargo is shipped at a Cwt cost of $2.1875 per Cwt, the shipping charge for shipping 841 pounds of goods from Alexandria, Ind. to Fayette, Ala. using the shared freight invoicing system of the present invention is $17.70 (8.41 Cwt×$2.1046 per Cwt) (Table 4).

Therefore, as shown on Table 4, the total shipping cost to the customer for the shipment from Lake Bluff, Ill. to Fayette, Ala., using the shared freight system is $79.48 ($61.78+$17.70). The savings realized using the shared freight system versus a conventional tariff-based shipping, therefore, is $29.80 or 27.3% ($109.28−$79.48).

TABLE 4
Shared Pricing

| Route | Pro# | Weight | Cwt | Amount | |
|---|---|---|---|---|---|
| Fayette | 307440 | 841 | 2.1046 | $17.70 | |
| Lake Bluff | 370135 | 841 | 7.3462 | $61.78 | |
| | | | | $79.48 | (total) |

It is understood that a paying customer's individual bill-of-lading weight, the total round trip shipping weight, fuel rates and other parameters are subject to variation with each day and each shipment. As a result, the savings realized by a paying customer using the present invention versus the conventional tariff-based shipping will also vary. This is because in the shared freight weight system of the present invention, the customer pays only for his/her portion of the freight weight of the total shipment freight weight.

Additionally, the shared freight system overcomes the problem in the prior art, wherein the customer is charged a rate independent of the contribution of the weight of the customer's goods to the weight of the total shipment. In the shared freight system, not only is the customer's cost always based on his/her portion of the weight of the total shipment, but as the total weight of the shipment is increased, the Cwt cost for each individual customer decreases.

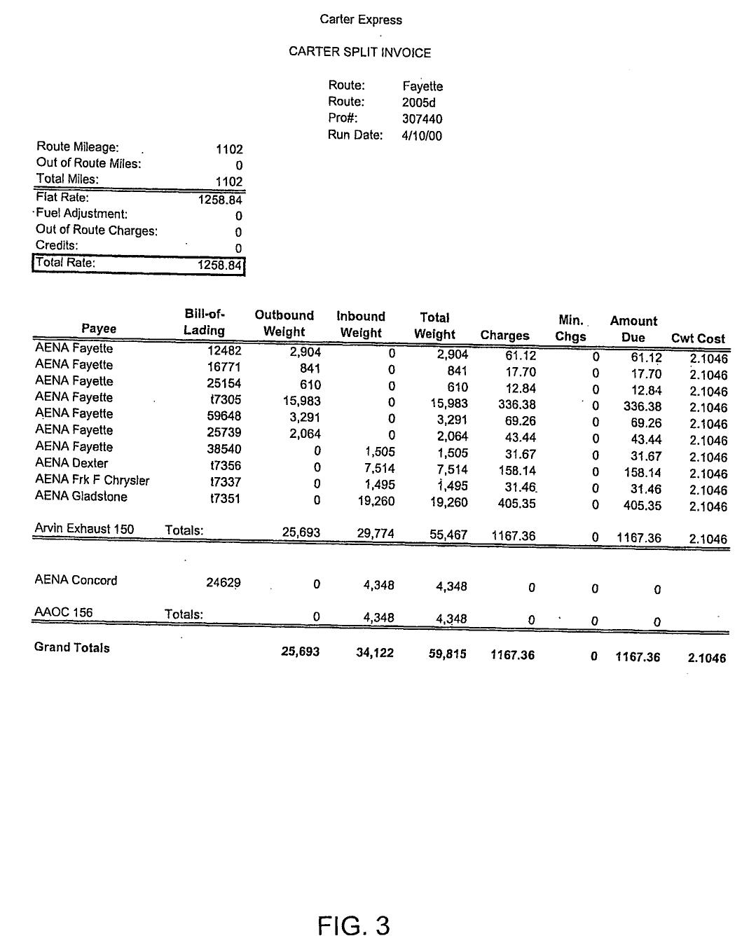

As shown on FIG. 3, the addition of another customer's (Tenneco) goods on the first leg of the shipment (the Lake Bluff leg) significantly decreases the cost of the shipment for the customer of the present example, Arvin Exhaust. As described above in FIG. 1, when the shipment total freight weight was 7,795 pounds, the Cwt cost to Arvin Exhaust was 7.3462 per Cwt. With the added goods, the shipment total freight weight of FIG. 3 is 37,993 pounds or a Cwt of 379.93 pounds. Using the present invention method for this shipment, the Cwt cost for Arvin Exhaust is then calculated as $572.65/379.93 pounds=1.5073 per Cwt. Thus, the cost to ship the 841 (or 8.41 Cwt) of cargo is $12.68 (8.41 Cwt×1.5073 per Cwt).

With the addition of more goods to the shipment, the Cwt cost for Arvin Exhaust is reduced from 7.3462 to 1.5073 and the cost is likewise reduced from $61.78 to $12.68. Consequently, the greater the total weight of goods per round trip, the less each paying customer's burden of the total shipment cost will be in accordance with the present method. As each paying customer more fully utilizes the available space and weight of the truck, each paying customer benefits by reducing the hundred weight cost. Thus, using the present invention, the cost savings are restricted only by the cubic capacity of the truck and the Department of Transportation (DOT) legal weight limitations.

III. Invoice Method of the Shared Freight System

The shared freight system also provides a unique system for invoicing customers. The standard customer information, such as billing method, minimum charges, credits and fixed costs are continuously maintained in a computer system. At the initiation of each shipping route, the route information, such as identification of all stops, total miles, tolls and bridge charges are loaded (populated) into the computer system. The individual customer rate per mile charges are also entered. Thus, the pre-loading of the computer system enables the carrier to request any or all routes for a particular day. Once the information has been loaded into the computer system, the information is then also available for tracking shipping routes and invoicing.

The specific customer information for each route is entered as the truck proceeds through the route. For example, the information on each bill-of-lading is transmitted to the computer for entry. As a result, both the information for each customer, as well as for the total shipment is then available in the computer. Loading the proper weight for each customer's goods permits the generation of the invoice based on the weight of the customer's goods as a portion of the total weight of the shipment.

FIGS. 1 and 2 show exemplary “split” invoices for a specific customer for a selected route. The “split” invoice is an invoice provided to a customer, which shows unique customer information along with specific information for that customer and the same specific information for each customer of a particular shipment. The percentage contribution by the customer is thereby apparent. A similar invoice is generated for each customer participating in a particular shipment. In the exemplary invoice, the specific information shown for each customer is its freight weight. The invoice lists of all the customers participating in the combined load for a selected route, with the specific weight contributions of each bill-of-lading identified for each customer. Accordingly, since the invoice is based on the freight weight of the customer's goods as a portion of the combined weight of the entire shipment, the invoice is apportioned by customer.

Accompanying each customer identifier, the invoice shows: the bill-of-lading number; the inbound, outbound, and total weight of each bill-of-lading. It also shows the sum of the freight weight for that customer. The total weights for each customer are summed and the total freight weight for the shipment is shown. This allows each customer to view his/her freight weight as a portion of the total shipment freight weight.

Even though the invoice for a specific route shows the bill-of-lading weights for all customers participating in the route, the unique charges for a particular customer are only provided on that customer's invoice. For instance, the rate per mile negotiated by each customer may vary; thus, the flat rate and total rate shown on a particular customer's invoice applies only to that customer on that selected route. Likewise, charges, such as minimum charges, for each customer appear only on that customer's invoice.

As shown in the exemplary invoice in FIG. 1, the shipment route and date are first identified as Lake Bluff, route #2008.d, run date Apr. 7, 2000. The total miles for the route are shown as 501.3. This information is not unique to a customer and will appear on all of the invoices for all of the customers on the particular route. The flat rate, any additional charges, and the total shipment rate are also shown. In the exemplary invoice of FIG. 1, the flat rate of $572.64, with no additional charges or credits, results in a total shipment cost of $572.64, which is a cost that is unique to that particular customer. For these categories, similar information, unique to each customer, will appear on each customer's invoice for the particular route.

The invoice then lists, segmented by customer, the customer identification, bill-of-lading number, associated weight for each bill-of-lading, and specific charges segmented by customer. As shown on FIG. 1, each invoice lists: every customer, his/her bill(s)-of-lading, the inbound, outbound and total weight for each bill-of-lading, and the total weight contribution for each customer participating in the combined load for the selected route. From the exemplary invoice of FIG. 1, the total weight for customer Arvin Exhaust, is 6,950 pounds. Also shown on the exemplary invoice is the total weight of the shipment of 7,795 pounds. Therefore, along with the listing of each bill-of-lading, the invoice provides to the customer, in this case Arvin Exhaust, its freight weight as a portion of the total freight weight of the combined shipment.

As previously indicated, the specific charges for each bill-of-lading are shown only on that customer's invoice. In the present example, the shipment of customer, Arvin Exhaust, for 841 pounds (bill-of-lading number 16771) generates a shipping rate of $61.78. Using the shared freight system described above, each bill-of-lading for the customer is itemized and the total charge for the customer is shown on the invoice as $1167.36.

Thus, the present method of invoicing provides the customer with detailed information of the charges. Moreover, the invoice provides each customer with the information used to generate the charges based on the customer's portion of the total freight weight of the combined load for the selected route. Thus, the present method of invoicing not only advantageously shows the customer the charges for its portion of the combined load, but how they were determined, while at the same time providing the customer with a significant savings over prior art invoicing methods for shipping the same partial load.

Each and every patent, patent application and publication that is cited in the foregoing specification is herein incorporated by reference in its entirety.

While the foregoing specification has been described with regard to certain preferred embodiments, and many details have been set forth for the purpose of illustration, it will be apparent to those skilled in the art that the invention may be subject to various modifications and additional embodiments, and that certain of the details described herein can be varied considerably without departing from the spirit and scope of the invention. Such modifications, equivalent variations and additional embodiments are also intended to fall within the scope of the appended claims.

What is claimed is:

1. A method of establishing a shipping charge for combined less-then-truckload (LTL) shipments, based on a customer's freight weight portion of the total shipment freight weight, comprising:
calculating the total shipping rate for the shipment based upon total route mileage and flat shipping rate;
calculating hundred weight cost for the shipment based upon hundred weight of the shipment further comprising, dividing total weight of the shipment, in pounds, by 100;
determining hundred weight of the customer's goods on the shipment; and
calculating the shipping cost to the customer.

2. The method according to claim 1, wherein after the route is determined the method further comprises calculating total mileage by summing all mileage between each stop on the route.

3. The method according to claim 1, wherein the total miles of the route are calculated from the zip codes of the shipment origin and shipment destination.

4. The method according to claim 1, wherein the flat shipping rate for the shipment is the total miles of the route multiplied by a customer negotiated rate per mile.

5. The method according to claim 1, wherein the total shipping rate for the shipment comprises the flat shipping rate for the shipment, plus any additional fees and charges that may be required.

6. The method according to claim 1, wherein the hundred weight of the customer's goods is the weight, in pounds, of the customer's shipment divided by one hundred.

7. The method according to claim 1, wherein the shipping cost to the customer is the customer's hundred weight multiplied by the hundred weight cost of the shipment.

8. The shipping charge produced in accordance with the method of claim 1 for a customer's LTL freight weight portion of a combined truckload shipment.

9. A method of invoicing-a customer of an LTL shipment based on the customer's portion of the total shipment weight of the combined load, comprising:
populating a database;
entering data from each bill-of-lading into a computer system linked to the database;
processing the data for a selected route; and
creating an invoice for each customer's portion of the combined load on the route.

10. The method according to claim 9, wherein the populated database comprises shipping route and flat rate data.

11. The method according to claim 9, wherein processing of the data further comprises creating a total rate for the shipment.

12. The method according to claim 9, wherein processing of the data further comprises computing the customer's hundred weight.

13. The method according to claim 12, wherein processing of the data further comprises computing cost for the customer's hundred weight.

14. The method according to claim 9, wherein invoicing for each customer comprises the compiling the following data for each customer on a combined load: information from each bill-of-lading, the weight of each bill-of-lading, and the sum of all bills-of lading for the combined load, and wherein the invoice information is apportioned by customer.

15. The method according to claim 9, wherein invoicing for each customer comprises: charges and an amount due for each bill-of-lading for that customer's portion of the combined load.

16. The method according to claim 9, wherein invoicing for each customer comprises hundred weight cost for that customer's portion of the combined load.

17. The method according to claim 9, wherein invoicing for each customer comprises the total amount due for that customer's portion of the combined load.

18. The invoice produced in accordance with the method of claim 9 for a customer's shipping charge for the customer's LTL freight weight portion of a combined truckload shipment.
